(19) United States
(12) Patent Application Publication
(10) Pub. No.: US 2010/0330541 A1
(43) Pub. Date: Dec. 30, 2010

(54) FOR STUDY, LEARNING AND REVIEW OF EDUCATIONAL MATERIALS

(76) Inventor: Andrew Charles Krakowski, La Jolla, CA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 12/693,928

(22) Filed: Jan. 26, 2010

Related U.S. Application Data
(60) Provisional application No. 61/147,428, filed on Jan. 26, 2009.

(51) Int. Cl. G09B 19/22; G09B 7/00; G09B 1/00

(52) U.S. Cl. 434/129; 434/362; 434/167

(57) ABSTRACT

Systems and methods for improving study are described. A study aid kit includes a study plan, activities and challenges. In one example, a study aid is embodied in a surface marked with a plurality of indicia and a plurality of markers identifies progress of the participants. Performance of the activity determines advancement according to the study plan. Activities are associated with one or more related human competencies. In certain embodiments, human competencies are selected from one of factual knowledge competencies, audio/visual performance/tactile/olfactory competencies, multidimensional graphic competencies and spelling/vocabulary/language competencies.

### CROSS-REFERENCE TO RELATED APPLICATIONS

The present Application claims priority from U.S. Provisional Patent Application No. 61/147,428 filed Jan. 26, 2009, which is expressly incorporated by reference herein for all purposes.

### BACKGROUND OF THE INVENTION

1. Field of the Invention

The present invention relates generally to learning aids and, more particularly, to teaching and study aids having multiple activities/techniques for stimulating multiple levels of brain function and recall.

2. Description of Related Art

In his 1983 book, Frames of the Mind: The Theory of Multiple Intelligences, Dr. Howard Gardner tries to explain why different people learn differently. To illustrate his position, Dr. Gardner distills human skills/activities down into eight core competencies that include the following: Language, spatial, logical-mathematical, musical, physical, interpersonal, intrapersonal, and natural. Using this approach, he explains that people who are strong in language, for example, tend to think in terms of words. Consequently, such individuals could be expected to better learn information when presented in written or verbalized form. The next group he calls spatial learners. These are people who are able to think in spatial terms, and they tend to excel at visualizing information. The third group he describes as logical-mathematical. These people could be expected to learn information by applying logic to systems and numbers. Musical learners—the fourth group—conceptualize information in musical ways and have an innate ability to understand and use music. Physical learners prefer to learn via a “hands-on” approach and learn best by doing. The sixth group, called interpersonals, has a strong ability to relate to others. Intrapersonals—the seventh group—include individuals who tend to be introspective, thoughtful, and reflective. Finally, natural learners are able to observe, understand, and organize patterns and enjoy collecting data and objects from the natural world.

In total, Dr. Gardner points out a fact that has been well-understood and long-recognized by educationalists: Different people learn differently. Perhaps most importantly, his work reaffirms the educational paradigm that different modalities of learning may be required in order to maximize an individual's learning potential.

Traditional study aids have failed to recognize this key point and focus solely on learning by reading (i.e., “language” based learning). Such an approach is not without disadvantages. First, current study aids only utilize one aspect of how we as humans learn new material; they are, in fact, language-based learning tools because they depend solely on reading as the primary means of internalizing new information and assessing retention of the new material. In the process, these study aids fail to make use of other competencies. Although such study aids are enjoyed by those who are skilled in the particular activity of the language-based learning process, they are not fulfilling to those who lack interest or skill in the particular language-based review activity. Thus, such study aids fail to appeal to a broader spectrum of people because they focus only on one review activity directed to a single skill. More specifically, traditional study aids fail to address other means of learning that require participants, for example, to utilize artistic skills, which will likely appeal to those who are strong in the spatial core competency classification. In total, traditional study aids do not appeal to those individuals whose capabilities are not within the core competency of the traditional “language-based” activity and, therefore, these individuals tend not to learn new material to their fullest potential. Second, current study aids (e.g., review books, question and answer assessment aids, etc.) inherently make studying in groups impractical because reading is almost always done more efficiently by an individual rather than in a group setting. Thirdly, traditional study aids currently make no attempt to directly reward participants for their effort to learn; rewards in these traditional study aids are limited only to intangible rewards (e.g., better test scores, improved self-confidence, approval from friends and family, etc.).

Particular fields of study use standardized tests as part of the given curriculum. In professional areas of study like medicine, for example, students must pass standardized licensing board exams before graduation, and most are required to take standardized “shelf exams” in subjects ranging from surgery and radiology to anatomy and molecular biology. Likewise, large introductory undergraduate courses like Bio 101 and Psych 101—taught in nearly every college in the country!—all rely on tests that cover the same material. Even high school students taking advanced placement (i.e., “A.P.”) courses like American History and English Literature take subject-specific standardized exams.

In an effort to prepare students to do well in these subjects, hundreds of 3rd party review books have already been published with good success and are on-sale at bookstores across the country.

### BRIEF DESCRIPTION OF THE DRAWINGS

FIG. 1 illustrates the general structure of a study aid according to certain aspects of the invention.

FIG. 2 depicts an example of a study aid structure for an anatomy subject.

FIG. 3 depicts a computing system that can be configured to perform the steps of processes described herein.

### BRIEF SUMMARY OF THE INVENTION

Certain embodiments of the invention comprise a study aid kit that can include a study aid surface marked with a plurality of indicia, a plurality of markers for positioning on the indicia of the study aid surface, and a plurality of decks of cards. Each deck may include a plurality of cards, wherein each card bears indicia instructing a participant to carry out an activity. Performance of the activity determines advancement of a marker on the study aid surface. Each deck contains cards directed to activities associated with one or more related human competencies. The human competencies of each deck typically differ at least in part from the competency or competencies associated with the activities of the cards contained in the other decks. Each deck contains at least a first subset of cards directed to a first activity type and a second subset of cards directed to a second activity type distinct from the first activity type.

In certain embodiments, human competencies are selected from one of factual knowledge competencies, audio/visual performance/tactile/olfactory competencies, two-dimensional and/or three-dimensional graphic competencies, and spelling/vocabulary/language competencies. Each deck of the study aid kit may further include at least a third subset of cards directed to a third activity type distinct from the first and second activity types.

In certain embodiments, the indicia on the study aid kit playing surface designates a set path around the study aid surface to track a participant's progression through the study session; advancement along the path corresponds to successful completion of sequential study aid activities and correlates with a participant's performance in the study session.

In certain embodiments, the study aid kit further includes direct-to-consumer coupons from third party partners that serve as tangible coupons, redeemable for tangible rewards as stated on the cards themselves and as provided by third party partners. The study aid kit may further include the ability to access additional online “multi-media” content, both proprietary and that provided by third party partners. In certain embodiments, the study aid kit enables individuals to access the study aid kit in a “solitaire” mode that permits review by an individual.

Aspects of the present invention incorporate certain elements of preexisting materials into innovative educational scenarios, which can be designed around thought-provoking, interactive multi-media experiences that help users master material on multiple and deeper brain levels. By changing the way test questions have traditionally been asked and by cleverly-disguising the entire production as “edu-tainment” users learn difficult subject material in an arena that feels more like a party than a library.

A “deep-learning” educational study aid kit includes a guided review surface (A) marked with a plurality of indicia (B). The educational review kit also includes a plurality of markers (C) for positioning on indicia of the guided review surface. A first deck of review cards (D) including a plurality of cards (E) is also included. Each card bearing instructions (F) for a person to carry out an activity that helps them better remember facts associated with the activity. The activity instructions of the cards in the first deck each being associated with a first core or cluster of human competencies selected from the group of factual knowledge competencies, audio/video performance competencies, two and/or three-dimensional graphic competencies, and spelling/vocabulary competencies. The plurality of cards contained in the first deck including at least a first subset of cards directed to a first activity type associated with the first core or cluster of competency(s) and a second subset of cards directed to a second activity type, distinct from the first activity type, associated with the first core or cluster of competency(s). The game also includes a second deck of cards having a plurality of cards bearing instructions for a player to carry out an activity. The second deck of cards contains cards directed to activities associated with a second core or cluster of human competency(s) different at least in part from the first core or cluster of competencies associated with the first deck. The game also includes a third deck of cards having a plurality of cards bearing instructions for a player to carry out an activity. The third deck of cards contains cards directed to activities associated with a third core or cluster of human competency(s) different at least in part from the first and second core or cluster of competencies associated with the first or second deck. The game also includes a fourth deck of cards having a plurality of cards bearing instructions for a player to carry out an activity. The fourth deck of cards contains cards directed to activities associated with a fourth core or cluster of human competency(s) different at least in part from the first, second, or third core or cluster of competencies associated with the first, second, or third deck. Performance of the activities on the cards of the first, second, third or fourth decks determining advancement of a person's marker on the guided review surface.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

Certain embodiments of the invention comprise a study aid kit that can include a study aid surface marked with a plurality of indicia, a plurality of markers for positioning on the indicia of the study aid surface, and a plurality of decks of cards. Each deck may include a plurality of cards, wherein each card bears indicia instructing a participant to carry out an activity. Performance of the activity determines advancement of a marker on the study aid surface. Each deck contains cards directed to activities associated with one or more related human competencies. The human competencies of each deck typically differ at least in part from the competency or competencies associated with the activities of the cards contained in the other decks. Each deck contains at least a first subset of cards directed to a first activity type and a second subset of cards directed to a second activity type distinct from the first activity type.

In certain embodiments, human competencies are selected from one of factual knowledge competencies, audio/visual performance/tactile/olfactory competencies, two-dimensional and/or three-dimensional graphic competencies, and spelling/vocabulary/language competencies. Each deck of the study aid kit may further include at least a third subset of cards directed to a third activity type distinct from the first and second activity types.

In certain embodiments, the indicia on the study aid kit playing surface designates a set path around the study aid surface to track a participant's progression through the study session; advancement along the path corresponds to successful completion of sequential study aid activities and correlates with a participant's performance in the study session.

In certain embodiments, the study aid kit further includes direct-to-consumer coupons from third party partners that serve as tangible coupons, redeemable for tangible rewards as stated on the cards themselves and as provided by third party partners. The study aid kit may further include the ability to access additional online “multi-media” content, both proprietary and that provided by third party partners. In certain embodiments, the study aid kit enables individuals to access the study aid kit in a “solitaire” mode that permits review by an individual.

Certain embodiments of the invention provide a study aid that has several advantages over conventional study aids. First, the study aid is entertaining and stimulating to a wider variety of players because it incorporates activities associated with multiple human core competencies. The study aid is also more challenging because it does not specialize in only one of the human core competencies, but rather includes activities from a plurality, if not all, of the core competencies. The study aid is appealing and stimulating to a wider variety of participants because it includes activities from each of the core competencies. Additionally, participants may be rewarded for studying and performance through direct-to-consumer partnerships that are acquired as participants use the study aid to learn. Moreover, the study aid enables group study that can produce beneficial results; the opportunity to build camaraderie and to generate memorable circumstances as a direct result of the study aid itself helps to make the process of learning enjoyable and improves recall over the long-term.

Certain embodiments of the invention provide an enhanced multimedia study kit. For example, the Internet may be employed to integrate multimedia into the process of learning. The study aid enables participants to listen to audio and/or view images. The study aid kit provides a more entertaining experience and enhanced content, accessibility, challenge and reward. Thus, embodiments of the invention tend to appeal to a broader spectrum of participants than conventional systems and permit individual and/or group study in real-life and virtual study activities though the Internet.

Certain embodiments of the invention provide learning systems and methods in a form that combines academic, social and leisure activities. Materials can be presented in a manner that makes studying more interactive and engaging, that utilizes different parts of the brain to help ensure better retention, which improves long-term retention of the materials. Moreover, the manner and forum of presentation of the materials reconciles the need for social activity and the need for dedicated study time while maintaining academic productivity

Certain embodiments comprise a board game in which materials are presented for learning purposes in a non-formal manner. It is anticipated that a board game format is familiar to most potential users of the learning and study aids described herein and the structure of the board game allows user to quickly become immersed in the study process and can, to some degree, conceal underlying technologies. It will be appreciated that other methods for tracking progress and structuring learning and studying processes may be used, including computer based interactive systems. In that regard, many tasks, assignments and challenges presented may be performed using computer-based and/or multimedia systems. However, a board-game based structure is adopted in this description, but only for the purposes of facilitating apprehension of the novel concepts, systems and methods.

The contemplated educational teaching-tools and memory-enhancing learning and review systems combine deep studying while entertaining users. Users can manage time more efficiently by effectively having a break in without taking an actual break. More specifically, users may utilize their brains in different ways while mastering educational material in a playful, exciting manner, thereby achieving productive leisure. Productive leisure may be defined to include a user's experience in the learning process which, of itself, builds camaraderie and generates memorable circumstances that, in turn, help make reviewed material available for recall over the long-term.

### Learning Models

Teaching/learning scenarios are created around innovative and interactive multi-media platforms that require deep-learning and multi-tiered brain function. According to certain aspects of the invention, traditional group-review is supported as well as review by network using networks infrastructure that can include one or more of Internet, cellular phone, pager/beeper and/or email. Content can include multimedia comprising material accessed via CD-ROMs, DVDs, and the Internet (through computers or handheld devices such as Blackberry, Palm Pilot, cell phones, pagers/beepers, etc.). The content may be updated periodically based on, for example, curriculum changes, advances in learning stages, user preference and for administrative reasons. Materials may be accessed using a bar code system imprinted on review cards that automatically indexes content and/or questions. Alternatively, a drawn card from the deck could provide instructions and access codes that enable the user to manually access networked or other resources.

In certain embodiments, review material can be arranged in one or more brain-function categories including the performance of activities related to specific educational activities, goals, and/or objectives. Activities related to the Frontal Lobe may include speech-related and executive function-related questions; for example, unscramble words, spell, spell backwards, guess definitions, create mnemonic, fill in the blanks, create a mnemonic, sort a list, mix and match, which does not belong and crack a code. Activities related to the hippocampus (memory-related questions) may include traditional question-and-answer, true/false questions, test your knowledge, which does not belong, prioritize/rank, make a list, definitions, multiple choice questions and fill in the blanks. Activities related to the cerebellum (movement- and action-related questions) may require making sounds as clues (hum, whistle, blow), impersonation, blinking/stomping/clapping clues (Morse code), charades/acting out clues and naming based on texture or touch. Activities related to the parietal lobe (spatial orientation- and perception-related questions) can include sketching, sculpting and drawing with eyes closed. Activities related to the temporal lobe (sensory questions) can include naming activities based on touch, sight, sound and/or smell.

### Board-based Review

In certain embodiments, a board game is provided in which users attempt to successfully complete specified activities in order to advance around a board or area where advancement around the board is representative of an individual or group's successful advancement through educational materials. A user's position of on the review board may also determine from which category of questions further educational material is selected. Individual users or groups of users take turns in which the users must complete the review activity described on a selected card. Typically, a timer is used to limit the activity to a predetermined maximum interval of time. If the user is successful, a marker corresponding to the user is advanced to the next placeholder on the review board, and the next individual or group takes its turn. If an individual or group fails to complete the activity, their turn is lost. The first individual or group to make it to the center of the review board and successfully answer questions/complete learning activities from one or more of the brain-function categories completes the review first session first.

Some review activities are marked for group review. These educational activities are performed in common, with all participants competing for control of the review board.

Another special category of cards includes those marked as real coupons; these cards may be saved for later use. Players can pull these cards out of the deck as they are answered for redemption at participating vendor locations.

### Virtual Review

Certain embodiments can be used for learning, teaching or reviewing a selected subject by accessing multi-media content maintained in a data repository or database, typically Internet-driven databases. For example, users can login to a review session and select a subject module they would like to review. In this mode, the computer unfolds a multi-media review scenario that forces the user to utilize multi-tiered brain function in order to succeed. Other models include a “subscription service” in which review questions are emailed, text messaged, etc. to the individual. Correct answers earn the users points, which are accumulated and may be exchanged for prizes and/or coupons. Users can play as individuals or review with other users who are logged on and reviewing similar material.

In certain embodiments, participants may use online social networking and/or other electronic forums. In one example, an established social networking environment such as Face Book or My Space may be used to connect individual users and/or groups of users for the purposes of review. In another example, a virtual world environment (e.g. Second Life) can be used as a method for congregation and review by users. In both of the preceding examples, a forum can be created specifically to host review, teaching and learning sessions. Connection to a virtual review can be made through networked computer and/or mobile communications devices. Typically, access is provided through systems and software that provide multimedia capabilities.

### Subject Modules

Certain embodiments can be employed to assist students from a variety of different backgrounds and educational levels learn material in the context of “deep-learning” and multi-tiered brain function. Consequently, systems may incorporate any number of different subject modules. By combining material taken from well-known “standardized review” providers with other educational sources (e.g., actual radiographic images, murmur sounds, news clips, maps, music files, etc.), games can be driven by multi-media materials. Potential subject modules can include Biology, U.S. Government and Politics, English Literature, Art History, Environmental Science, Human Geography, U.S. History, World History, Psychology, Bar Review (“Law”), GMAT, GRE, MCAT, Series 7 exams, Veterinarian licensing exams, Internal Medicine, Pediatrics, Dental licensing exams, OB/GYN, Surgery, Psychiatry, Biochemistry, Genetics, Anatomy and Medical licensing exams (USMLE Step 1, 2, 3).

### Direct To Consumer Marketing

Certain embodiments innovatively and uniquely reward users for teaching, learning or reviewing. Extra Credit™ coupons from partnering sponsors interested in advertising their messages/products directly to consumers Randomly can be interspersed throughout educational scenarios (either board-based or virtual). When a reward is drawn from the pile of questions or selected virtually, users are able to redeem it for the advertised reward. In other words, the question itself becomes a coupon. Even single players using the online review mode can participate. Virtual coupons may be printed or may—based on the vendor—be accepted electronically (for example, by showing an electronic coupon on a Blackberry screen or cell phone display).

Additionally, participation points are typically accumulated through the successful completion of either board-based or virtual-based review activities. At any point, users may exchange accumulated points for corporate sponsor-driven products. This is similar to a credit card-based “rewards system” or the airline industry's “frequent flyer miles” system.

### Tournament Model

In order to foster a community of learning and healthy academic competition, certain embodiments may include a tournament-based model in which users convene in designated locations in order to interact and learn in a formally-structured group setting. Involvement including at local, regional, state, national, and international levels is contemplated. A component of this model may be a performance-based rewards system that includes scholarships and/or other prizes for users.

### EXAMPLE

### Board-based Review

In one example of a game, set up includes a plurality of steps. Users may be divided into study groups of two or more people. Up to four teams may play at once in the example. A speed of play is agreed among the groups. An average game takes about 60 minutes using a 6-sided die and 1-minute timed turns. For faster play, an 8- or 10-sided die can be used and/or the timer can be set for less time. A roll of the die may be used to determine which team goes first. For example, highest roll goes first, moving left to right. Each team's individual members may sit in the order that they will play for their team, moving left to right. A placeholder is placed on the START space on the board. (The START space is the area where four colored boxes are “stacked” to form a square, located on the left side of the board.)

The question cards may be shuffled and dealt face down by color into four separate piles. Each of the four colored-coded decks may be placed in their corresponding color-coded deck box so that no one can see a question before a card is actually drawn. The deck boxes may be placed on top of their colored-coded spaces on the Brain Drain board. The timer may be set out with a tub of molding clay and each group is provided a pencil and some paper.

In the example, during play, a user/group begins with a corresponding placeholder on the START space. On the first turn, the current team chooses from which colored-coded deck your card will be drawn. A first team member draws the top card from the corresponding color-coded deck and reads it privately in order that the other team members cannot see the answer. Hints provided on the card may be read aloud at this time. The timer is started and runs for a maximum agreed turn time. The current team attempts to complete the activity described on the drawn card before time runs out. If the current team is successful in completing the activity, the die is rolled and the team placeholder is advanced by the number of spaces indicated on the die. If unsuccessful, the placeholder remains in place (i.e., the team does not roll the dice and does not advance) and awaits the next turn for the team to attempt to complete an activity from this same color-coded deck. Regardless of success, the next team in sequence (typically, to the left takes a turn). On subsequent turns, the colored spaces upon which the placeholder lies dictates which color-coded deck are used to supply review cards.

In certain embodiments, some cards may be marked with a “Collective Conscious” symbol (e.g., two brains connected by a corpus callosum). Activities designated by these cards are performed in common, with each team competing with one another for a bonus roll. In other words, it's a “free-for-all.” Upon drawing a Collective Conscious card, normal review is temporarily suspended, with all teams competing to earn a bonus roll. Each team chooses one person to present the activity on the card (draw, sculpt, act, etc.) to his/her team. Unless otherwise provided, timers apply as in normal turns. If no team has completed the task when time runs out, the activity continues until success is achieved. The first team to correctly complete the activity makes a bonus roll of the die. The group review (and subsequent bonus roll) is independent of which team drew the card originally. Once the winning team makes its bonus roll and moves forward, the team which drew the Collective Conscious card draws another card for its normal turn and normal review resumes (unless another Collective Conscious card is drawn.

Certain embodiments include extra credit cards. These cards double as actual coupons to reward students for studying. They may be used later during a study break. Players should pull these cards out of the deck as they are answered so that they may be redeemed at participating vendor locations. At times, it may occur that two or more teams end up on the same color-coded space. As soon as this happens, normal review is temporarily suspended. The “cohabitating” teams each designate a player to lead the teams in attempting to complete an activity. The next card from the color-coded deck is drawn, and the selected players are given the chance to read the card's instructions. The first team to correctly complete the activity makes a bonus roll of the die. In some embodiments, no one moves forward but the losing team moves back by the number of spaces indicated by the die.

Upon traveling completely around the board, a team will eventually make it into Final Exams, typically an area designated by color-coded spaces with, e.g., a black circle in their center. The team decides which Final Exam category should be attempted to closeout first. The placeholder is moved to the corresponding color-coded space and control passes to the next in sequence team. When control returns, the team in the Final Exam section attempts to successfully complete the review activity as for any other normal turn. When successfully completed, a card proving completion of the Final Exam activity is retained as proof of the accomplishment. After successfully closing-out a category, a team decides which Final Exam category will be subsequently attempted on the next turn and the placeholder is moved onto the corresponding Final Exam space. If unsuccessful in a Final Exam activity, the team stays in place tries again until successfully passing the Final Exam in each of the four color-coded categories. In certain embodiments, Collective Conscious cards count toward Final Exams. If a Collective Conscious activity is won while on a Final Exam space, the card may be kept if it is the activity class needed.

When a team has passed each of the four Final Exams, the placeholder may be moved to a final location, herein referred to as the “Chairman of the Bored spot” (the only spot on the board where teams can share the same space). On the next turn, the other teams collectively choose the color-coded category for the team's final activity. If unsuccessful, the team must wait until its next turn to try again. The team that is first to successfully complete an activity while sitting on the Chairman of the Bored space wins, or is “graduated.”

A “deep-learning” educational study aid kit includes a guided review surface (A) marked with a plurality of indicia (B). The educational review kit also includes a plurality of markers (C) for positioning on indicia of the guided review surface. A first deck of review cards (D) including a plurality of cards (E) is also included. Each card bearing instructions (F) for a person to carry out an activity that helps them better remember facts associated with the activity. The activity instructions of the cards in the first deck each being associated with a first core or cluster of human competencies selected from the group of factual knowledge competencies, audio/video performance competencies, two and/or three-dimensional graphic competencies, and spelling/vocabulary competencies. The plurality of cards contained in the first deck including at least a first subset of cards directed to a first activity type associated with the first core or cluster of competency(s) and a second subset of cards directed to a second activity type, distinct from the first activity type, associated with the first core or cluster of competency(s). The game also includes a second deck of cards having a plurality of cards bearing instructions for a player to carry out an activity. The second deck of cards contains cards directed to activities associated with a second core or cluster of human competency(s) different at least in part from the first core or cluster of competencies associated with the first deck. The game also includes a third deck of cards having a plurality of cards bearing instructions for a player to carry out an activity. The third deck of cards contains cards directed to activities associated with a third core or cluster of human competency(s) different at least in part from the first and second core or cluster of competencies associated with the first or second deck. The game also includes a fourth deck of cards having a plurality of cards bearing instructions for a player to carry out an activity. The fourth deck of cards contains cards directed to activities associated with a fourth core or cluster of human competency(s) different at least in part from the first, second, or third core or cluster of competencies associated with the first, second, or third deck. Performance of the activities on the cards of the first, second, third or fourth decks determining advancement of a person's marker on the guided review surface.

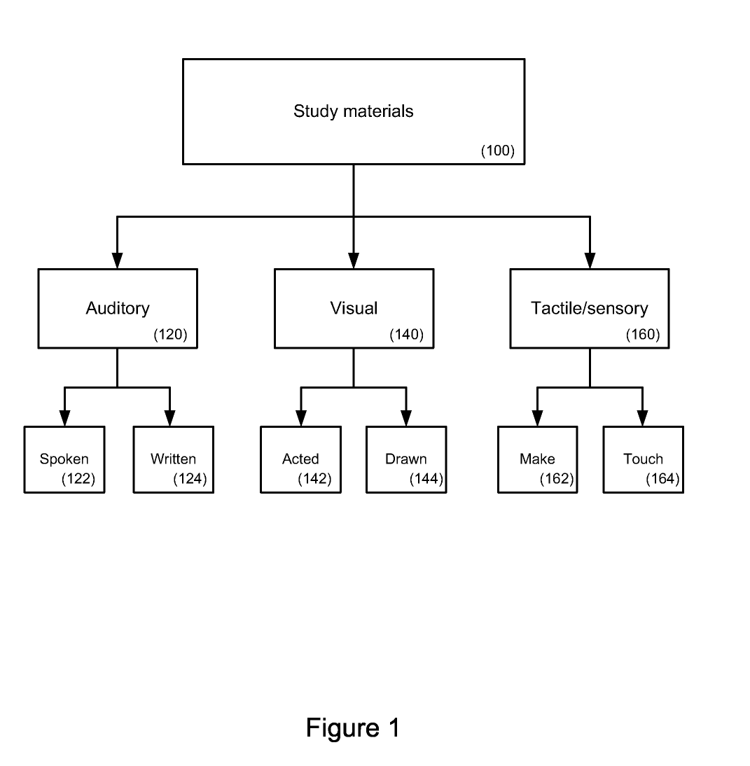

FIG. 1 provides an overview of certain aspects of the invention. Specific study aids are assembled based on the study material 100 to be addressed. Some material may be reviewed and/or learned most easily using tactile methods 160. For example, modeling clay and/or sculpting putty can be used to construct models 162 that represent an object or system to be reviewed. The models may constructed 162 by a first participant and identified by vision on tactile senses by one or more other participants. To maintain interest, points and other rewards can be offered for both the making and identifying participants.

Other material may be reviewed and/or characterized visually 140. Visual representations of materials can be provided by actions of a participant 142 and/or by drawing 144. Drawing 144 can often be performed using multimedia tools and the process of creating a visual presentation and identification of materials can be rewarded by points and/or other incentives. Certain material may require memorization and/or an ability to describe or recognize descriptions. For example, diagnosis of conditions based on patient descriptions may be practiced using verbal descriptions 122 or some combination of verbal 122 and written 124 presentation. Information can be generated using a repository of recorded materials, which may be selected automatically using computers. Information may be presented from short or long term memory of participants.

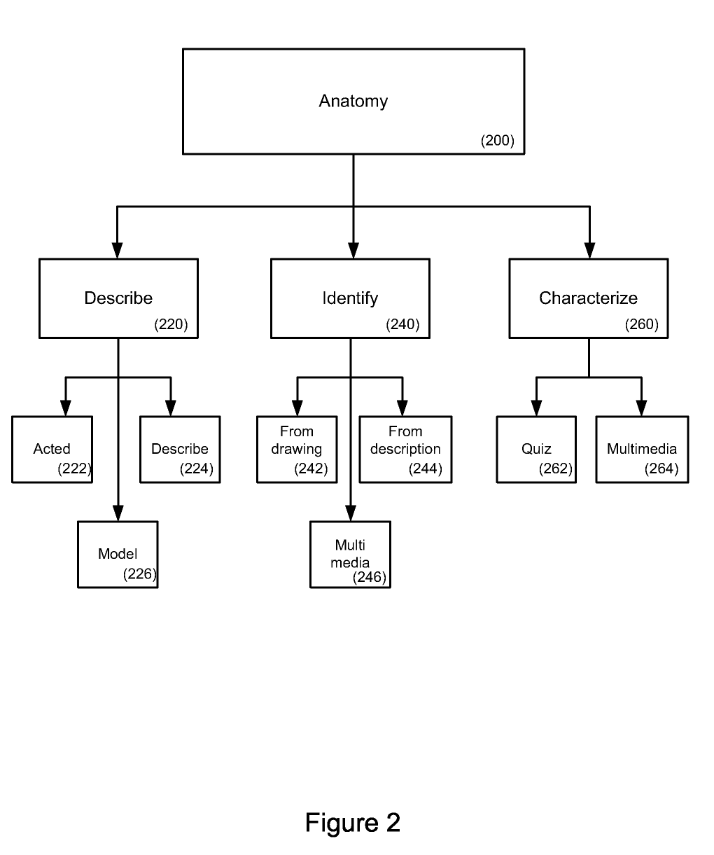

Turning now to FIG. 2, a more specific example is offered that can include auditory 120, visual 122 and tactile 124 processes. In this example, human or animal anatomy 200 is under review. Review includes providing descriptions 220 of anatomical elements and structures, identifying anatomical elements and structures 240 and characterizing anatomical elements and structures 260. Descriptions 220 may be provided by actions 222 of participants whereby the participant illustrates location, motion and other features. Descriptions 220 may be provided by verbal or written presentation 224, including quizzes, word play in both oral and written form. Descriptions 220 may be made using modeling 226. For example, a rotator cuff may be modeled using modeling clay or the like. The model may be required to operate consistently with the modeled part or structure. Modeling 226 may also include building structures from prefabricated parts.

Identification 240 can be made from drawings, 242, oral or written description 244 and/or using multimedia presentations 246 including video, audio and 3D graphics, for example. Characterization 260 is frequently performed after identification 240 and/or description 220 of an element or structure. Characterization 260 can be used to review detailed aspects of a subject of study. Materials can be reviewed by quiz 262 and or by interactive multimedia presentation 264. Quizzes 262 can be managed using a computer system to provide questions and score answers. Quizzes 262 can be adaptive, whereby weaknesses are identified based on answers provided and questions can be selected to assist learning. Multimedia presentations 264 may be used to identify subject matter, present questions and provide an ability for participants to manipulate the multimedia presentation. For example, a touch screen display may present a rotator cuff and a participant may be challenged to demonstrate typical and/or atypical movement of the rotator cuff.

It will be appreciated that much benefit can be derived by in-person group participation in study sessions using techniques and technologies described herein. However, it is contemplated that materials can be presented in a collaborative on-line format such that participants may use available multimedia technology to receive and present information to other participants and the management system. Moreover, teams of participants can meet in person and compete against other teams in remote locations. Thus, the interactive and competitive benefits of the described systems may be obtained even in geographically dispersed groups.

As mentioned above, the description uses a board game format as an example for the purposes of description. However, other familiar themes may be used to accomplish certain objectives of the invention. For example, ubiquitous game consoles and/or multimedia computers may be used as a format. To that end, familiar gaming procedures, icons and avatars may be used to present study material. Likewise, mobile devices that provide multimedia capabilities may be used. It is contemplated that continuous online sessions may be thus enabled, whereby a user of the system may participate as needed in any available group session, thereby providing study-on-demand capabilities.

### System Description

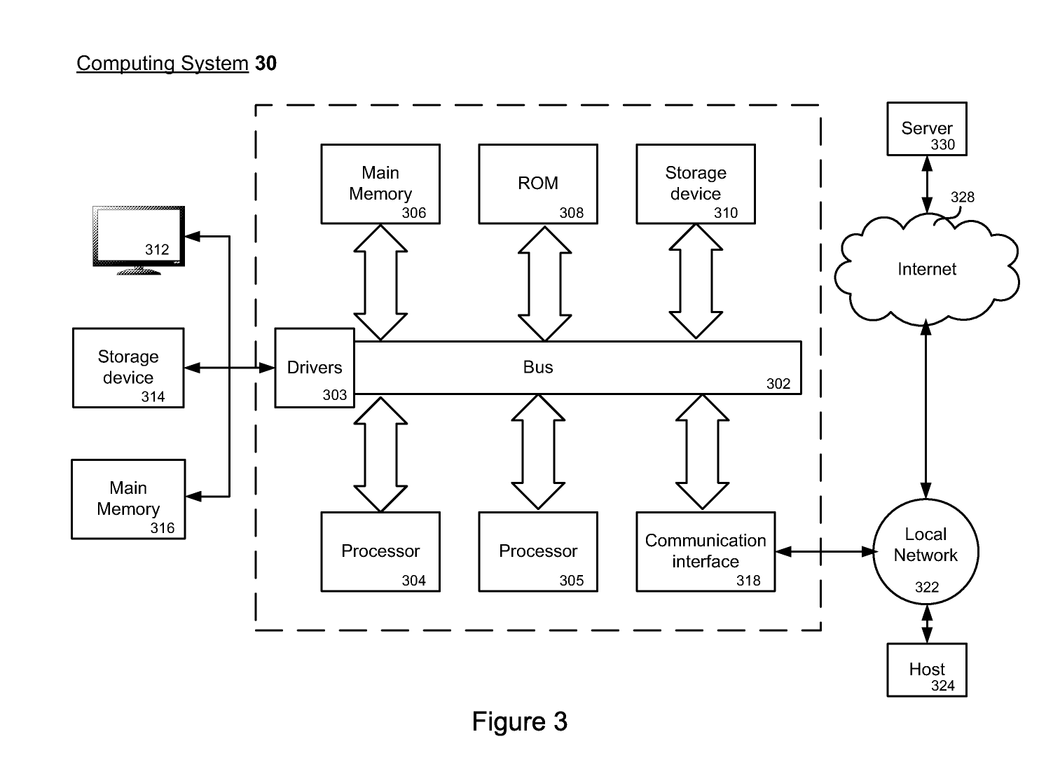

Turning now to FIG. 3, certain embodiments of the invention employ a processing system that includes at least one computing system 300 deployed to perform certain of the steps described above. For example, a computing device may be used to provide access to challenges presented in regard to a specific topic, to allow a participant to draw or otherwise model a subject of a question or challenge and/or to present multimedia materials associated with a current topic. Computing systems may comprise a commercially available system that executes commercially available operating systems such as Microsoft Windows®, UNIX or a variant thereof, Linux, a real time operating system and/or a proprietary operating system. The architecture of the computing system may be adapted, configured and/or designed for integration in the processing system, for embedding in one or more of an image capture system, a manufacturing/machining system, a graphics presentation device and/or a multimedia system that includes a display and audiovisual components.

In one example, computing system 300 comprises a bus 302 and/or other mechanisms for communicating between processors, whether those processors are integral to the computing system 30 (e.g. 304, 305) or located in different, perhaps physically separated computing systems 300. Device drivers 303 may provide output signals used to control internal and external components. Computing system 300 also typically comprises memory 306 that may include one or more of random access memory (“RAM”), static memory, cache, flash memory and any other suitable type of storage device that can be coupled to bus 302. Memory 306 can be used for storing instructions and data that can cause one or more of processors 304 and 305 to perform a desired process. Main memory 306 may be used for storing transient and/or temporary data such as variables and intermediate information generated and/or used during execution of the instructions by processor 304 or 305. Computing system 300 also typically comprises non-volatile storage such as read only memory (“ROM”) 308, flash memory, memory cards or the like; non-volatile storage may be connected to the bus 302, but may equally be connected using a high-speed universal serial bus (USB), Firewire or other such bus that is coupled to bus 302. Non-volatile storage can be used for storing configuration, and other information, including instructions executed by processors 304 and/or 305. Non-volatile storage may also include mass storage device 310, such as a magnetic disk, optical disk, flash disk that may be directly or indirectly coupled to bus 302 and used for storing instructions to be executed by processors 304 and/or 305, as well as other information.

Computing system 300 may provide an output for a display system 312, such as an LCD flat panel display, including touch panel displays, electroluminescent display, plasma display, cathode ray tube or other display device that can be configured and adapted to receive and display information to a user of computing system 300. Typically, device drivers 303 can include a display driver, graphics adapter and/or other modules that maintain a digital representation of a display and convert the digital representation to a signal for driving a display system 312. Display system 312 may also include logic and software to generate a display from a signal provided by system 300. In that regard, display 312 may be provided as a remote terminal or in a session on a different computing system 300. An input device 314 is generally provided locally or through a remote system and typically provides for alphanumeric input as well as cursor control 316 input, such as a mouse, a trackball, etc. It will be appreciated that input and output can be provided to a wireless device such as a PDA, a tablet computer or other system suitable equipped to display the images and provide user input.

According to one embodiment of the invention, study materials may be managed and presented by computing system 300 in which processor 304 executes one or more sequences of instructions. Such instructions may be stored in main memory 306, having been received from a computer-readable medium such as storage device 310. Execution of the sequences of instructions contained in main memory 306 causes processor 304 to perform process steps according to certain aspects of the invention. In certain embodiments, functionality may be provided by embedded computing systems that perform specific functions wherein the embedded systems employ a customized combination of hardware and software to perform a set of predefined tasks. Embodiments of the invention are not limited to any specific combination of hardware circuitry and software.

The term “computer-readable medium” is used to define any medium that can store and provide instructions and other data to processor 304 and/or 305, particularly where the instructions are to be executed by processor 304 and/or 305 and/or other peripheral of the processing system. Such medium can include non-volatile storage, volatile storage and transmission media. Non-volatile storage may be embodied on media such as optical or magnetic disks, including DVD, CD-ROM and BluRay. Storage may be provided locally and in physical proximity to processors 304 and 305 or remotely, typically by use of network connection. Non-volatile storage may be removable from computing system 304, as in the example of BluRay, DVD or CD storage or memory cards or sticks that can be easily connected or disconnected from a computer using a standard interface, including USB, etc. Thus, computer-readable media can include floppy disks, flexible disks, hard disks, magnetic tape, any other magnetic medium, CD-ROMs, DVDs, BluRay, any other optical medium, punch cards, paper tape, any other physical medium with patterns of holes, RAM, PROM, EPROM, FLASH/EEPROM, any other memory chip or cartridge, or any other medium from which a computer can read.

Transmission media can be used to connect elements of the processing system and/or components of computing system 300. Such media can include twisted pair wiring, coaxial cables, copper wire and fiber optics. Transmission media can also include wireless media such as radio, acoustic and light waves. In particular radio frequency (RF), fiber optic and infrared (IR) data communications may be used.

Various forms of computer readable media may participate in providing instructions and data for execution by processor 304 and/or 305. For example, the instructions may initially be retrieved from a magnetic disk of a remote computer and transmitted over a network or modem to computing system 300. The instructions may optionally be stored in a different storage or a different part of storage prior to or during execution. Computer readable material may comprise a DVD, USB drive and/or other removable component that stores study materials and/or encoded instructions that cause one or more processors to present the study materials and manage challenges.

Computing system 300 may include a communication interface 318 that provides two-way data communication over a network 320 that can include a local network 322, a wide area network or some combination of the two. For example, an integrated services digital network (ISDN) may used in combination with a local area network (LAN). In another example, a LAN may include a wireless link. Network link 320 typically provides data communication through one or more networks to other data devices. For example, network link 320 may provide a connection through local network 322 to a host computer 324 or to a wide are network such as the Internet 328. Local network 322 and Internet 328 may both use electrical, electromagnetic or optical signals that carry digital data streams. T

Computing system 300 can use one or more networks to send messages and data, including program code and other information. In the Internet example, a server 330 might transmit a requested code for an application program through Internet 328 and may receive in response a downloaded application that provides for the anatomical delineation described in the examples above. The received code may be executed by processor 304 and/or 305.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for a study aid kit. Some of these embodiments comprise a study aid surface marked with a plurality of indicia. Some of these embodiments comprise a plurality of markers for positioning on selected indicia of the study aid surface. Some of these embodiments comprise a plurality of decks, each deck including a plurality of cards, each card bearing indicia instructing a participant to carry out an activity, performance of the activity determining advancement of a marker on the study aid surface. In some of these embodiments, each deck contains cards directed to activities associated with one or more related human competencies. In some of these embodiments, the one or more related human competencies is different at least in part from the competencies associated with the activities of the cards contained in the other decks. In some of these embodiments, each deck contains at least a first subset of cards directed to a first activity type and a second subset of cards directed to a second activity type distinct from the first activity type.

In some of these embodiments, the human competencies include one or more of a factual knowledge competency, an audio competency, a visual competency, an olfactory competency, a tactile performance competency, a two-dimensional graphic competency, a three-dimensional graphic competency, a spelling competency, a vocabulary competency and a language competency. In some of these embodiments, the factual knowledge competencies are directed to one or more of a true/false question and answer activity, a multiple choice question and answer activity, a fill-in-the-blank question and answer activity and a fact based question and answer activity. In some of these embodiments, the activities included in the deck of cards directed to the audio/visual/tactile/olfactory performance competencies are selected from the group consisting of humming or whistling as a means of reproducing a particular sound, mimicking a person/place/thing, identifying a specific smell, identifying a specific texture, and acting. In some of these embodiments, the activities included in the deck of cards directed to the two and/or three-dimensional graphic competencies are selected from the group consisting of drawing with the participant's eyes open, drawing with the participant's eyes closed, sculpting, and drawing. In some of these embodiments, the activities of the cards included in the deck of cards directed to the spelling/vocabulary/language competencies are selected from the group consisting of rearranging letters to correctly spell a word, spelling a word backwards, giving the correct definition of a word, spelling a word and filling in a blank or blanks to correctly spell a word.

Some of these embodiments comprise at least a third subset of cards directed to a third activity type distinct from the first and second activity types. In some of these embodiments, the indicia on the study aid playing surface designating a path around the study aid surface to track a participant's progression through the study session. Some of these embodiments comprise a tub of sculpting putty. In some of these embodiments, the study aid playing surface comprises a rigid board. In some of these embodiments, the study aid surface and markers are represented in a multi-media environment. In some of these embodiments, the multi-media environment comprises a computer based reviewing environment or an electronic reviewing environment.

Certain embodiments of the invention provide systems and methods for an educational or study aid. Some of these embodiments comprise a plurality of collections of activity instructions, each collection including a plurality of activity instructions, each activity instruction bearing instructions for a player to carry out an activity, performance of the activity determining the participant's progression through the review session. In some of these embodiments, each collection of activity instructions contains activity instructions directed to activities associated with one or more related human competencies. In some of these embodiments, the one or more related human competencies is different at least in part from the competency(s) associated with the activity instructions contained in the other collection(s). In some of these embodiments, each collection of activities contains at least a first subset of activity instructions directed to a first activity type and a second subset of activity instructions directed to a second activity type distinct from the first activity type.

In some of these embodiments, the human competencies is selected from the group consisting of factual knowledge competencies, audio/visual/tactile/olfactory performance competencies, two and/or three-dimensional graphic competencies, and spelling, vocabulary and/or language competencies. Some of these embodiments comprise a plurality of decks of cards, the cards containing the collections of activity instructions, wherein each card containing the activity instructions. In some of these embodiments, the activities included in the deck of cards directed to the factual knowledge competencies are selected from the group consisting of true/false question and answer activity, multiple choice question and answer activity, and fact based questions. In some of these embodiments, the activities included in the deck of cards directed to the audio/visual/tactile/olfactory performance competencies are selected from the group consisting of humming/whistling/mimicking/reproducing a sound, mimicking a person/place/thing, and acting. In some of these embodiments, the activities in the deck of cards directed to the two and/or three-dimensional graphic competencies are selected from the group consisting of drawing with the participant's eyes closed, sculpting, and drawing. In some of these embodiments, the activities included in the deck of cards directed to the spelling, vocabulary and/or language competencies are selected from the group consisting of rearranging letters to correctly spell a word, spelling a word backwards, giving the correct definition of a word, spelling a word, and filling in a blank or blanks to correctly spell a word.

Some of these embodiments comprise at least a third subset of activity instructions directed to a third activity type distinct from the first and second activity types. Some of these embodiments comprise a study aid surface and a plurality of markers, the study aid playing surface being marked with a plurality of indicia, the markers for positioning on indicia of the study aid to track progression through the review session. In some of these embodiments, the indicia on the study aid surface designating the path around the study aid surface to track a participant's progression through the review session. In some of these embodiments, the study aid surface comprises a rigid board. Some of these embodiments comprise a tub of sculpting putty. In some of these embodiments, the study aid surface and markers are represented in a multi-media environment. In some of these embodiments, the multi-media environment comprises a computer based reviewing environment or an electronic reviewing environment.

Certain embodiments of the invention provide systems and methods for educational and study aids. Some of these embodiments comprise selecting one of a plurality of decks of cards, each deck including a plurality of cards, each card bearing instructions for a participant to carry out an activity. Some of these embodiments comprise selecting a card from the selected deck, the deck containing at least a first subset of cards directed to a first activity type and a second subset of cards directed to a second activity type distinct from the first activity type. Some of these embodiments comprise performing the activity associated with the instructions on the selected card. Some of these embodiments comprise tracking the progress of the participant in the review session based on performance of the activity. In some of these embodiments, each deck contains cards directed to activities associated with one or more related human competencies. In some of these embodiments, the one or more related human competencies is different at least in part from the competency associated with the cards contained in the other decks. In some of these embodiments, the human competencies is selected from the group consisting of factual knowledge competencies, audio/visual performance competencies, two and/or three-dimensional graphic competencies, and spelling/vocabulary/language competencies.

Certain embodiments of the invention provide systems and methods for a study aid kit. Some of these embodiments comprise a study aid board marked with a plurality of indicia. Some of these embodiments comprise a plurality of markers for positioning on indicia of the study aid board. Some of these embodiments comprise a first deck of cards including a plurality of cards. In some of these embodiments, each card bearing instructions for a participant to carry out an activity. In some of these embodiments, the activity instructions of the cards in the first deck each being associated with a first human core competency selected from the group consisting of factual knowledge competencies, audio/visual/tactile/olfactory performance competencies, two and/or three-dimensional graphic competencies, and spelling/vocabulary competencies. In some of these embodiments, the plurality of cards contained in the first deck comprising at least a first subset of cards directed to a first activity type associated with the first core competency and a second subset of cards directed to a second activity type, distinct from the first activity type, associated with the first core competency. Some of these embodiments comprise a second deck of cards, the second deck including a plurality of cards bearing instructions for a participant to carry out an activity, wherein the second deck of cards contains cards directed to activities associated with a second human core competency different at least in part from the first core competency associated with the first deck, performance of the activities on the cards of the first and second decks determining advancement of a participant's marker on the study aid board. Some of these embodiments comprise at least a third subset of cards directed to a third activity type associated with the first core competency and distinct from the first and second activity types.

Certain embodiments of the invention provide an interactive study aid. Some of these embodiments comprise a study aid surface marked with a plurality of indicia. Some of these embodiments comprise a plurality of markers for positioning on selected indicia of the study aid surface. Some of these embodiments comprise a plurality of decks. In some of these embodiments, each deck includes a plurality of cards. In some of these embodiments, each card bear indicia instructing a participant to carry out an activity, performance of the activity determining advancement of a marker on the study aid surface. In some of these embodiments, each deck contains cards directed to activities associated with one or more related human competencies In some of these embodiments, the one or more related human competencies is different at least in part from the competencies associated with the activities of the cards contained in the other decks. In some of these embodiments, each deck contains at least a first subset of cards directed to a first activity type and a second subset of cards directed to a second activity type distinct from the first activity type.

In some of these embodiments, the human competencies include one or more of a factual knowledge competency, an audio competency, a visual competency, an olfactory competency, a tactile performance competency, a two-dimensional graphic competency, a three-dimensional graphic competency, a spelling competency, a vocabulary competency and a language competency. In some of these embodiments, the factual knowledge competencies are directed to one or more of a true/false question and answer activity, a multiple choice question and answer activity, a fill-in-the-blank question and answer activity and a fact based question and answer activity. In some of these embodiments, the activities included in the deck of cards directed to one or more of an audio, visual, tactile and olfactory performance competency. In some of these embodiments, the one or more competency including at least one of humming, whistling, mimicking, identifying a smell, identifying a texture and acting.

In some of these embodiments, the activities included in the deck of cards are directed to a multi-dimensional graphic competency comprising at least one of drawing and sculpting. Some of these embodiments comprise at least a third subset of cards directed to a third activity type distinct from the first and second activity types. In some of these embodiments, the indicia on the study aid playing surface designating a path around the study aid surface to track a participant's progression through the study session. Some of these embodiments comprise a tub of sculpting putty. In some of these embodiments, the study aid surface and markers are represented in a multi-media environment. In some of these embodiments, the multi-media environment comprises a computer based reviewing environment or an electronic reviewing environment.

Certain embodiments of the invention provide study aid system. Some of these embodiments comprise storage for maintaining information that includes plurality of challenges, grouped according to a learning activity and including different instructions. In some of these embodiments, each instruction is directed to one of a first and a second participant. Some of these embodiments comprise an interactive multimedia presentation system that provides information to the participants and receives from the participants one or more responses to challenges. In some of these embodiments, the information includes activity instructions directed to activities associated with one or more related human competencies. In some of these embodiments, certain of the activities are performed by the first participant and other activities are performed by the second participant.

In some of these embodiments, the human competencies include multidimensional graphic competencies. In some of these embodiments, the human competencies include competencies associated with factual knowledge. In some of these embodiments, the interactive multimedia presentation system provides challenges based on a study plan associated with the participants. In some of these embodiments, the study plan is modified based on the one or more responses. In some of these embodiments, a plurality of participants is situated in different locations and at least one participant participates using a network. Certain embodiments of the invention provide methods for managing a study group and study activities. Some of these embodiments comprise provide a plurality of topics. In some of these embodiments, the activities include challenges to be addressed by participants. In some of these embodiments, each topic is associated with a subject to be studied by a plurality of participants. Some of these embodiments comprise providing a plurality of activities. In some of these embodiments, each activity is defined by one or more instructions directed to one of the participant, wherein each activity is related to one or more human competencies. In some of these embodiments, successful completion of a challenge advances a participant in the study plan. Some of these embodiments comprise providing a scoring mechanism that measures the performance of an activity related to a topic by one of the participants. Some of these embodiments comprise providing an incentive scheme that includes a point system based on the scoring mechanism. In some of these embodiments, the plurality of topics and the plurality of activities cover a subject of study by the participants. In some of these embodiments, each topic is covered according to a study plan provided to the participants. In some of these embodiments, the study plan is embodied in a board game. In some of these embodiments, the study plan is managed by a computer. In some of these embodiments, the activities include multimedia interactive activities.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. An interactive study aid, comprising:
a study aid surface marked with a plurality of indicia;
a plurality of markers for positioning on selected indicia of the study aid surface; and
a plurality of decks, each deck including a plurality of cards, each card bearing indicia instructing a participant to carry out an activity, performance of the activity determining advancement of a marker on the study aid surface, wherein:
each deck contains cards directed to activities associated with one or more related human competencies, wherein the one or more related human competencies is different at least in part from the competencies associated with the activities of the cards contained in the other decks; and
each deck contains at least a first subset of cards directed to a first activity type and a second subset of cards directed to a second activity type distinct from the first activity type.

2. The study aid kit of claim 1, wherein the human competencies include one or more of a factual knowledge competency, an audio competency, a visual competency, an olfactory competency, a tactile performance competency, a two-dimensional graphic competency, a three-dimensional graphic competency, a spelling competency, a vocabulary competency and a language competency.

3. The study aid kit of claim 2, wherein the factual knowledge competencies are directed to one or more of a true/false question and answer activity, a multiple choice question and answer activity, a fill-in-the-blank question and answer activity and a fact based question and answer activity.

4. The study aid kit of claim 2, wherein the activities included in the deck of cards directed to one or more of an audio, visual, tactile and olfactory performance competency, the one or more competency including at least one of humming, whistling, mimicking, identifying a smell, identifying a texture and acting.

5. The study aid kit of claim 2, wherein the activities included in the deck of cards are directed to a multi-dimensional graphic competency comprising at least one of drawing and sculpting.

6. The study aid kit of claim 2, further comprising at least a third subset of cards directed to a third activity type distinct from the first and second activity types.

7. The study aid kit of claim 1, wherein the indicia on the study aid playing surface designating a path around the study aid surface to track a participant's progression through the study session.

8. The study aid kit of claim 8, further comprising a tub of sculpting putty.

9. The study aid kit of claim 1, wherein the study aid surface and markers are represented in a multi-media environment.

10. The study aid kit of claim 11, wherein the multi-media environment comprises a computer based reviewing environment or an electronic reviewing environment.

11. A study aid system comprising:
storage for maintaining information that includes plurality of challenges, grouped according to a learning activity and including different instructions, each instruction directed to one of a first and a second participant; and
an interactive multimedia presentation system that provides information to the participants and receives from the participants one or more responses to challenges, wherein
the information includes activity instructions directed to activities associated with one or more related human competencies, and wherein
certain of the activities are performed by the first participant and other activities are performed by the second participant.

12. The system of claim 11, wherein the human competencies include multidimensional graphic competencies.

13. The system of claim 12, wherein the human competencies include competencies associated with factual knowledge.

14. The study aid of claim 11, wherein the interactive multimedia presentation system provides challenges based on a study plan associated with the participants.

15. The study aid of claim 11, wherein the study plan is modified based on the one or more responses.

16. The study aid of claim 11, wherein a plurality of participants is situated in different locations and at least one participant participates using a network.

17. A method of managing a study group, comprising:
providing a plurality of topics, each topic associated with subject to be studied by a plurality of participants;
providing a plurality of challenges, each activity being defined by one or more instructions directed to one of the participant, wherein each challenge is related to one or more human competencies and wherein successful completion of a challenge advances a participant in the study plan;
providing a scoring mechanism that measures the performance of a challenge related to a topic by one of the participants;
providing an incentive scheme that includes a point system based on the scoring mechanism, wherein
the plurality of topics and the plurality of activities cover a subject of study by the participants and wherein each topic is covered according to a study plan provided to the participants.

18. The method of claim 17, wherein the study plan is embodied in a board game.

19. The method of claim 17, wherein the study plan is managed by a computer.

20. The method of claim 17, wherein the activities include multimedia interactive activities.
